(19) United States
(12) Patent Application Publication
(10) Pub. No.: US 2007/0226469 A1
(43) Pub. Date: Sep. 27, 2007

(54) Permutable address processor and method

(76) Inventors: James Wilson, Foxboro, MA (US); Joshua A. Kablotsky, Carlisle, MA (US); Yosef Stein, Sharon, MA (US); Colm J. Prendergast, Cambridge, MA (US); Gregory M. Yukna, Norton, MA (US); Christopher M. Mayer, Dover, MA (US); John A. Hayden, Sharon, MA (US)

Correspondence Address: Iandiorio & Teska, 260 Bear Hill Road, Waltham, MA, 02451-1018, US

(21) Appl. No.: 11/368,879

(22) Filed: Mar. 6, 2006

(51) Int. Cl. G06F 9/44

(52) U.S. Cl. 712/225; 712/300

(57) ABSTRACT

Accommodating a processor to process a number of different data formats includes loading a data word in a first format from a first storage device; reordering, before it reaches the arithmetic unit, the first format of the data word to a second format compatible with the native order of the arithmetic unit; and vector processing the data word in the arithmetic unit.

### FIELD OF THE INVENTION

This invention relates to a permutable address mode processor and method implemented between the storage device and arithmetic unit.

### BACKGROUND OF THE INVENTION

Earlier computers or processors had but one compute unit and so processing of images, for example, proceeded one pixel at a time where one pixel has eight bits (byte). With the growth of image size there came the need for high performance heavily pipelined vector processing processors. A vector processor is a processor that can operate on an entire vector in one instruction. Single Instruction Multiple Data (SIMD) is another form of vector oriented processing which can apply parallelism at the pixel level. This method is suitable for imaging operations where there is no dependency on the result of previous operations. Since an SIMD processor can solve similar problems in parallel on different sets of data it can be characterized as n times faster than a single compute unit processor where n is the number of compute units in the SIMD. For SIMD operation the memory fetch has to present data to each compute unit every cycle or the n speed advantage under utilized. Typically, for example, in a thirty-two bit (four byte) machine data is loaded over two buses from memory into rows in two thirty-two bit (four byte) registers where the bytes are in four adjacent columns, each byte having a compute unit associated with it. Then a single instruction can instruct all compute units to perform in its native mode the same operation on the data in the registers byte by byte in the same column and store the thirty-two bit result in memory in one cycle. In 2D image processing applications, for example, this works well for vertical edge filtering. But for horizontal edge filtering where the data is stored in columns, all the registers have to be loaded before operation can begin and after completion the results have to be stored a byte at a time. This is time consuming and inefficient and becomes more so as the number of compute units increases.

SIMD or vector processing machines also encounter problems in accommodating “little endian” and “big endian” data types. “Little endian” and “Big-endian” refer to which bytes are most significant in multi byte types and describe the order in which a sequence of bytes is stored in processor memory. In a little-endian system, the least significant byte in the sequence is stored at the lowest storage address (first). “Big-endian ” does the opposite: it stores at the lowest storage address the most significant byte in the sequence Currently systems service all levels from user interface to operating system to encryption to low level signal processing. This leads to “mixed endian” applications because usually the higher levels of user interface, and operating system are done in “little endian” whereas the signal processing and encryption are done in “big endian.” Programmers must, therefore, provide instructions to transform from one to the other before the data is processed or to configure the processing to work with the data in the form it is presented.

Another problem encountered in SIMD operations is that the data actually has be to spread or shuffled or permutated for presentation for the next step in the algorithm . This requires a separate step, which involves a pipeline stall, before the data is in the format called for by the next step in the algorithm.

### SUMMARY OF THE INVENTION

It is therefore an object of this invention to provide an improved processor and method with a permutable address mode.

It is a further object of this invention to provide such an improved processor and method with a permutable address mode which improves the efficiency of vector oriented processors such as SIMD's.

It is a further object of this invention to provide such an improved processor and method with a permutable address mode which effects permutations in the address mode external to the arithmetic unit thereby avoiding pipeline stall.

It is a further object of this invention to provide such an improved processor and method with a permutable address mode which can unify data presentation thereby unifying problem solution, reducing programming effort and time to market.

It is a further object of this invention to provide such an improved processor and method with a permutable address mode which can unify data presentation thereby unifying problem solution, utilizing more arithmetic units and faster storing of results.

It is a further object of this invention to provide such an improved processor and method with a permutable address mode in which the data can be permuted on the load to efficiently utilize the arithmetic units in its native form and then permuted back to its original form on the store which makes load, solution and store operations faster and more efficient.

It is a further object of this invention to provide such an improved processor and method with a permutable address mode which easily accommodates mixed endian modes.

It is a further object of this invention to provide such an improved processor and method with a permutable address mode which enables fast, easy, and efficient reordering of the data between compute operations.

It is a further object of this invention to provide such an improved processor and method with a permutable address mode which enables data in any form to be reordered to a native domain form of the machine for fast, easy processing and then if desired to be reordered back to its original form.

The invention results from the realization that a processor and method can be enabled to process a number of different data formats by loading a data word from a storage device and reordering it to a format compatible with the native order of the vector oriented arithmetic unit before it reaches the arithmetic unit and vector processing the data word in the arithmetic unit. See U.S. Pat. No. 5,961,628, entitled LOAD AND STORE UNIT FOR A VECTOR PROCESSOR, by Nguyen et al. and VECTOR VS. SUPERSCALAR AND VLIW ARCHITECTURES FOR EMBEDDED MULTIMEDIA BENCHMARKS, by Christoforos Kozyrakis and David Patterson, In the Proceedings of the 35^{th} International Symposium on Microarchitecture, Istanbul, Turkey, November 2002, 11 pages, herein incorporated in their entirety by these references.

The subject invention, however, in other embodiments, need not achieve all these objectives and the claims hereof should not be limited to structures or methods capable of achieving these objectives.

This invention features a processor with a permutable address mode including an arithmetic unit having a register file. At least one load bus and at least one store bus interconnecting the register file with a storage device. And a permutation circuit in at least one of the buses for reordering the data elements of a word transferred between the register file and storage device.

In a preferred embodiment the load and store buses may include a permutation circuit. There may be two load buses and each of them may include a permutation circuit. The permutation circuit may include a map circuit for reordering the data elements of a word transferred between the register file and storage device and/or a transpose circuit for reordering the data elements of a word transferred between the register file and storage device. The register file may include at least one register. The map circuit may include at least one map register. The map register may include a field for every data element. The map register may be loadable from the arithmetic unit. The map registers may be default loaded with a big endian little endian map. The data elements may be bytes.

This invention also feature a method of accommodating a processor to process a number of different data formats including loading a data register with a word from a storage device, reordering it to a second format compatible with the native order of the vector oriented arithmetic unit before it reaches the arithmetic unit data register file, and vector processing the data register in said arithmetic unit In a preferred embodiment the result of vector processing may be stored in a second data register device. The stored result may be reordered to the first format. The second storage device and the first storage device may be included in the same storage.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram for a processor with permutable address mode according to this invention;

FIG. 2 is a more detailed diagram of the processor of FIG. 1;

FIG. 3 is a diagrammatic illustration of big endian load mapping according to this invention;

FIG. 4 is a diagrammatic illustration of little endian load mapping according to this invention;

FIG. 5 is a diagrammatic illustration of another load mapping according to this invention;

FIG. 6 is a diagrammatic illustration of a store mapping according to this invention;

FIG. 7 is a diagrammatic illustration of a transposition according to this invention;

FIG. 8 A-C illustrates the application of this invention to image edge filtering;

FIG. 9 is a more detailed schematic of a map circuit according to this invention;

FIG. 10 is a more detailed schematic of a transpose circuit according to this invention; and

FIG. 11 is a flow chart of the method according to this invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

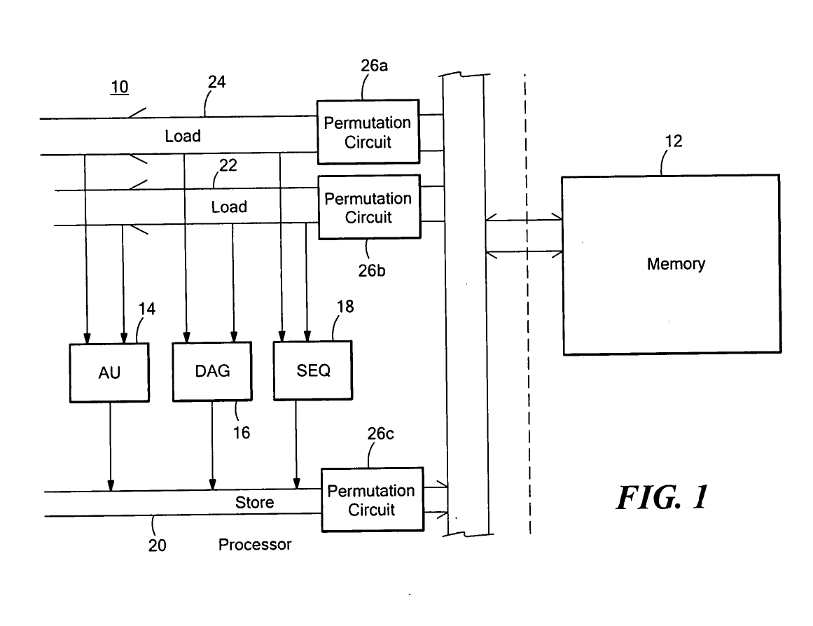

There is shown in FIG. 1 a processor 10 according to this invention accompanied by an external storage device, memory 12. Processor 10 typically includes an arithmetic unit 14, digital data address generator 16, and sequencer 18 which operate in the usual fashion. Data address generator 16 is the controller of all loading and storing with respect to memory 12 and sequencer 18 controls the sequence of instructions. There is a store bus 20 and one or more load buses 22 and 24 interconnecting the various ones of arithmetic unit 14, and data address generator 16 with external memory 12. In one or more of buses 20, 22 and 24 there is disposed a permutation circuit 26a, b, c, according to this invention.

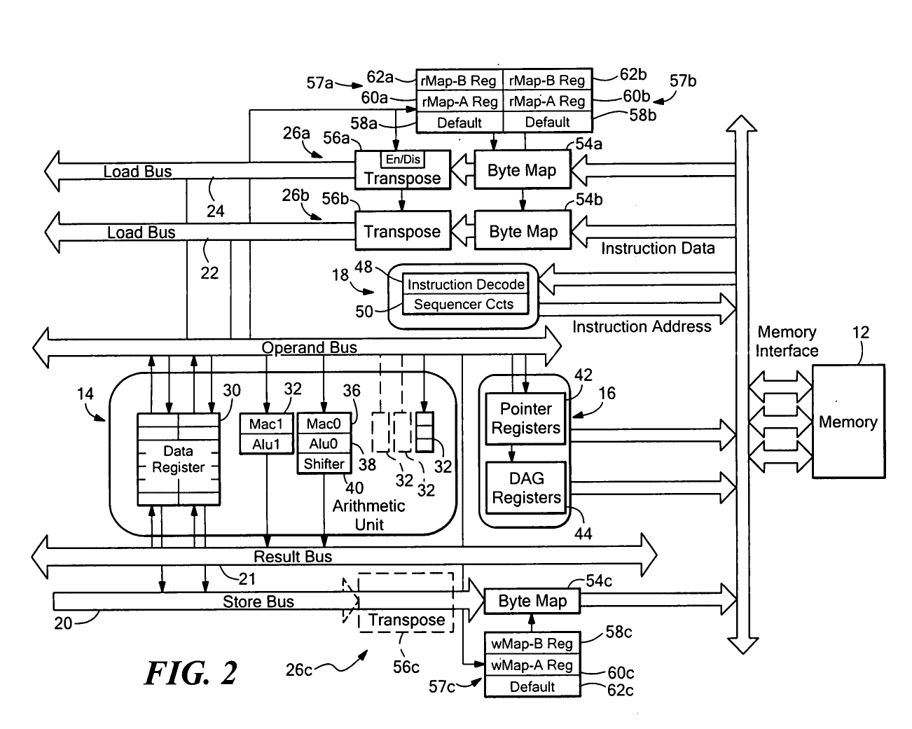

Arithmetic unit 14, FIG. 2, typically includes a data register file 30 and one or more compute units 32 which may contain, for example, multiply accumulator circuits 36, arithmetic logic units 38, and shifters 40 all of which are serviced by result bus 21. As is also conventional, data address generator 16 includes pointer registers 42 and data address generator (DAG) registers 44. Sequencer 18 includes instruction decode circuit 48 and sequencer circuits 50. Each permutation circuit 26a, 26b, and 26c, as exemplified by permutation circuit 26a, may include one or both of a map circuit 54a, b and transpose circuit 56a, b. Associated with each map circuit as explained with respect to map circuit 54a is a group of registers 57a which includes default register 58a and additional map registers, such as map A register 60a and map B register 62a. Each map register contains the instructions for a number of different mapping transformations. For example, the default registers 58a and 58b may be set to do a big endian transformation. A big endian transformation is one in which the lowest storage address byte in the sequence is loaded into the most significant byte stage of the register and the information in the highest address location is loaded into the least significant byte position of the register.

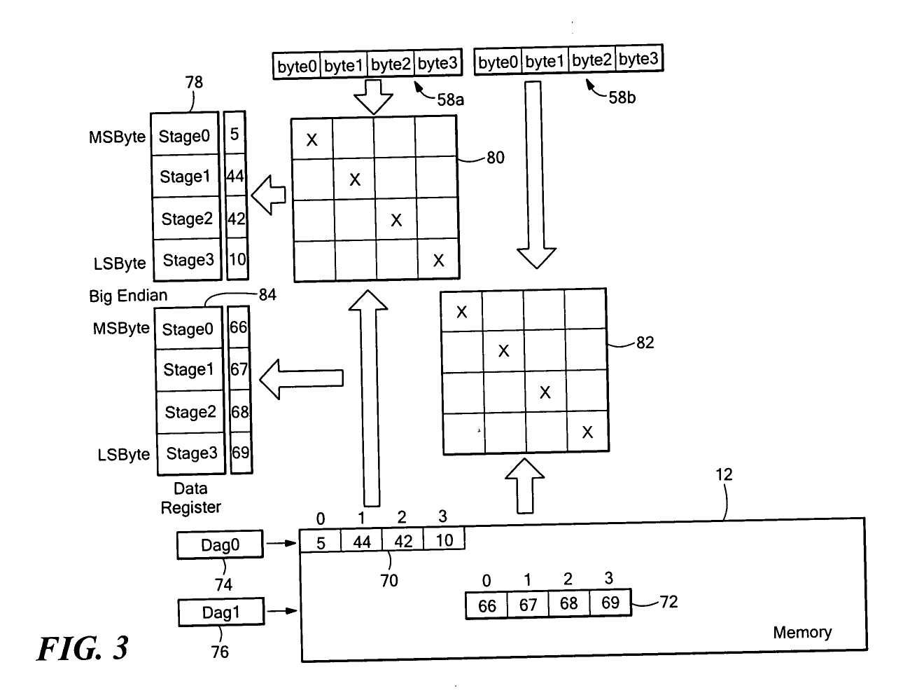

For example, as shown in FIG. 3, there are two data words, 70 and 72 stored in memory 12 each one has four byte data elements, in this case bytes, identified as 0, 1, 2, and 3. In word 70 byte 0, 1, 2, and 3 contain the values 5, 44, 42 and 10 respectively, while in word 72 the data sequences or bytes 0, 1, 2, 3 contain the values 66, 67, 68 , and 69. There are two pointer registers in the data address generator 44, pointer register 74 and 76. Pointer register 74 addresses word 70 while pointer register 76 addresses word 72. In accordance with the instructions in default register 58a, word 70 will be mapped to data register 78 according to matrix 80, or, byte 0 in word 70 goes to stage 0 of data register 78, byte 1 of word 70 goes to stage 1 of data register 78, byte 2 of word 70 goes to stage 2 of data register 78 and byte 3 of word 70 goes to stage 3 of data register 78. In this way the lowest address, byte 0 with a value of 5, ends up in the most significant byte stage of data register 78 and the storage highest address, byte three of value 10, ends up in the least significant byte stage, stage 3 of data register 78. It can be seen that the application of the instructions in map register 58b applied in matrix 82 moves bytes 0, 1, 2, and 3 of word 72 having values of 66, 67, 68, and 69, respectively, into data register 84 with the same big endian conversion. That is, the zero byte of word 72 with a value of 66 is in the most significant byte stage of register 84 and the value 69 of the highest address byte 3 of word 72 is in the least significant byte stage of data register 84.

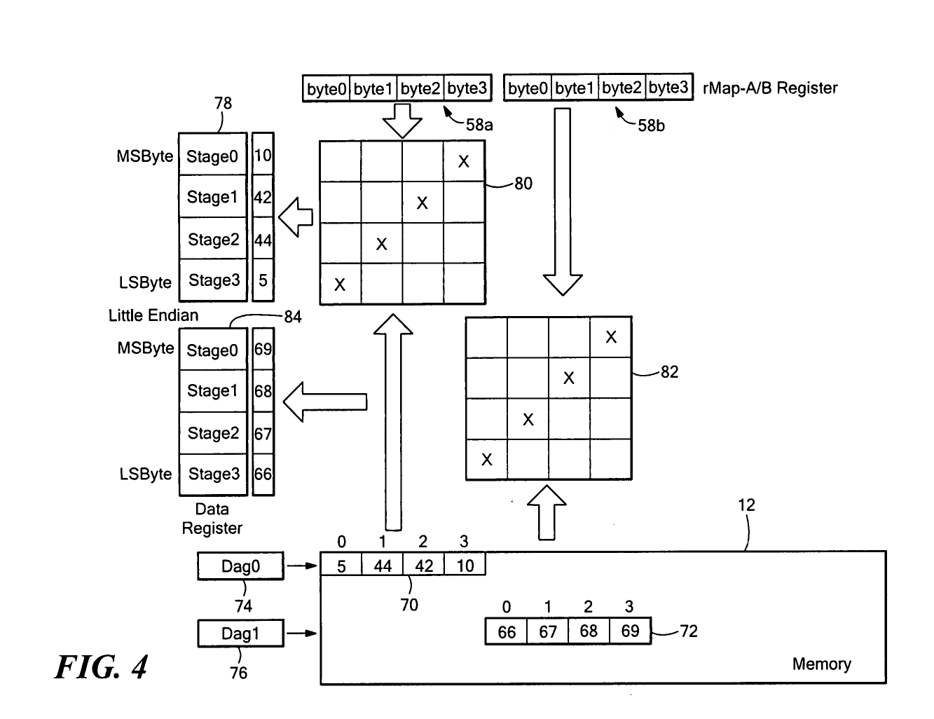

A little endian transformation is accomplished in a similar fashion, FIG. 4, with the default instructions in default registers 58a and 58b. In the resulting arrangement of matrix 80 and matrix 82 in this little endian transformation the lowest storage address byte ends up in the least significant byte stage of each of the data registers 78, and 84.

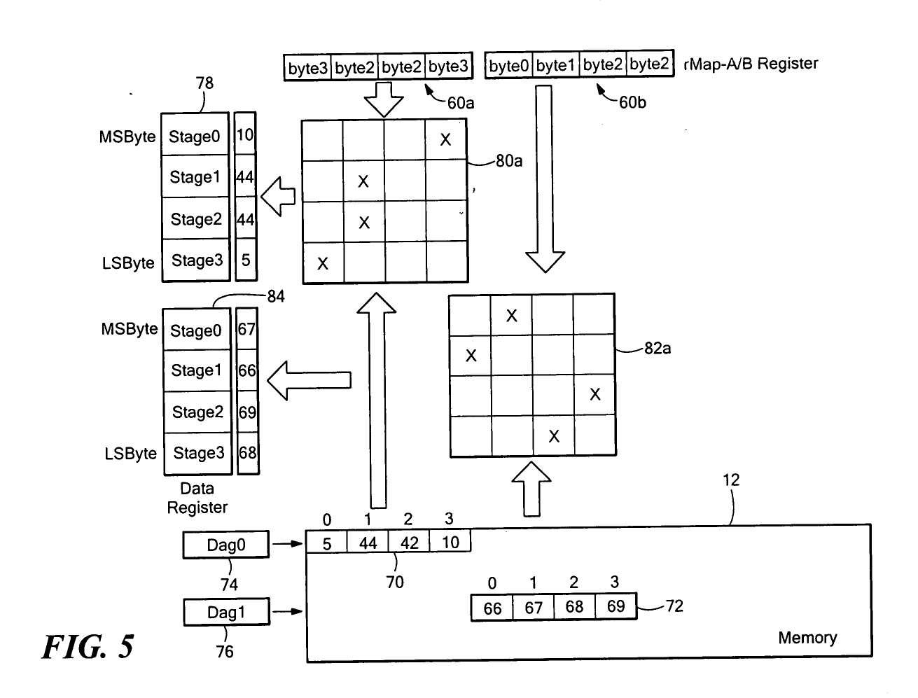

The big endian and little endian mapping shown in FIGS. 3 and 4, respectively, are straight forward but the mapping of this invention is not limited to that, any manner of spreading or shuffling can be accomplished with this invention. For example, as shown in FIG.5, map register 60a may program the logic matrix 80a to place byte 3 of word 70 in the most significant byte stage, place byte 1 in the next two stages, place byte 0 in the least significant byte stage, and ignore byte 2. Similarly, in word 72 map register 60b may cause byte 1 of word 72 to be placed in the most significant byte stage of data register 84, byte 0 to be placed in the next stage, byte 3 to be placed in the next stage and byte 2 to be placed in the least significant byte stage. The permutation circuit can be used in either or both of the load buses 22 and 24 and can also be used in the store bus.

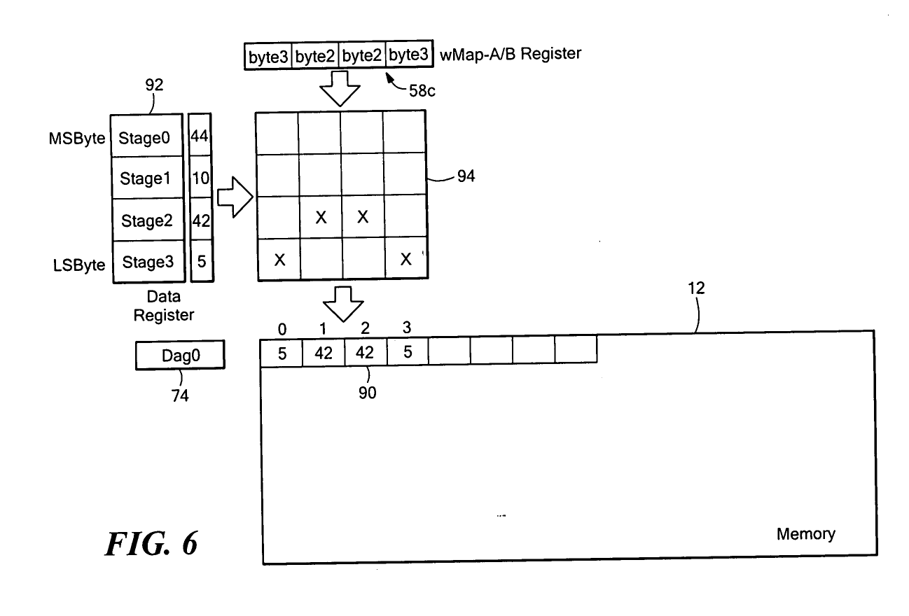

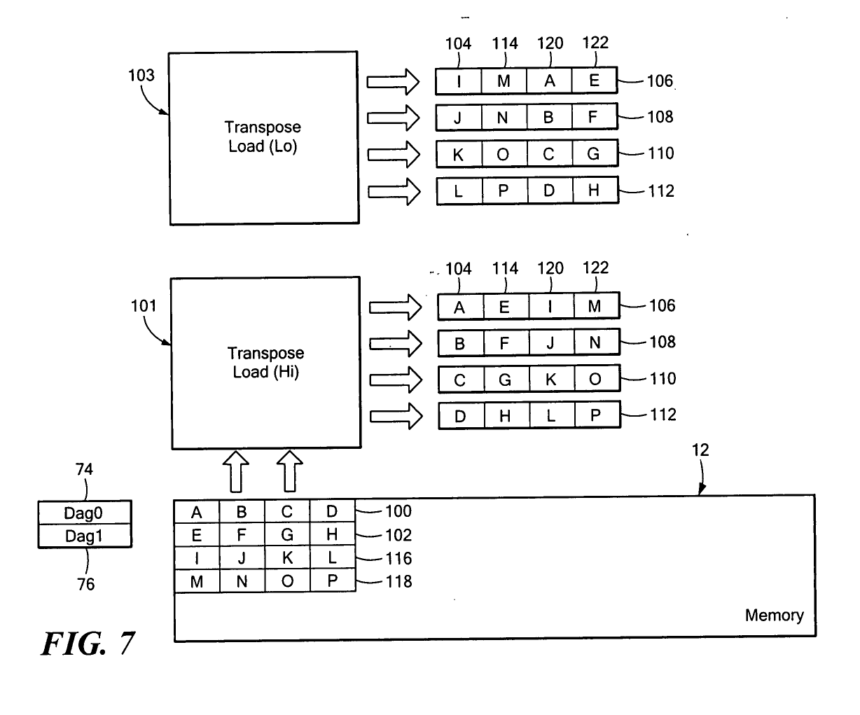

Data register 92, FIG. 6, may be delivering a word 90 to memory 12 there map A or map B register 58c or 68c will provide a mapping matrix 94 which simply ignores the contents of the most significant byte stage and the next stage in data register 92 and places the value in the least significant byte stage of data register 92 in byte positions 0 and 3 of word 90 while placing the values from stage 2 of register 92 in byte positions 1 and 2 of word 90. While the mapping occurs from a register and a portion of the memory or storage the transposing done by the transpose circuits 56a, 56b and 56c can actually go from storage or memory to a number of registers or from a number of registers to storage device For example, in FIG. 7, pointer register 74 and pointer register 76 address location 100 and 102 in memory 12 The word in memory 100 is a thirty-two bit word in four bytes, A, B, C and D likewise the word in memory 102 is a thirty-two bit word having four bytes E, F. G and H. One transposition identified as “transpose high” 101 takes memory bytes A, B, C, D and load them into the first column 104 of four data registers 106, 108, 110 and 112. Pointer register 76 takes the four bytes E, F, G and H from memory location 102 and places them in the next column 114 of the same four data registers 106, 108, 110, and 112. DAG pointer register 74 and 76 can next be indexed to memory locations 116, and 118 in memory 12 to place their bytes I, J, K, L and M, N, 0 P in columns. 120 and 122 respectively. In a “transpose low” mode 103 bytes A, B, C, D will be placed in column 120 bytes E, F, G, H in column 122, bytes I, J, K, L in column, 104 and bytes N, M, 0, P in column 114.

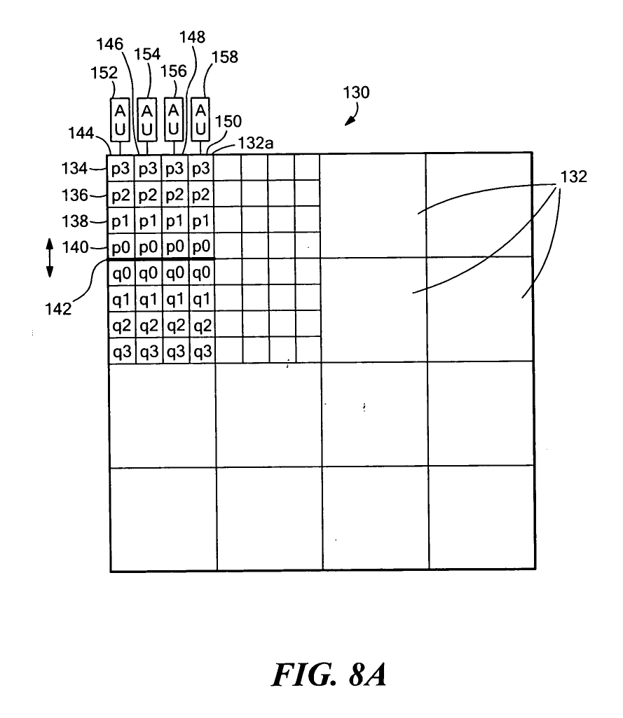

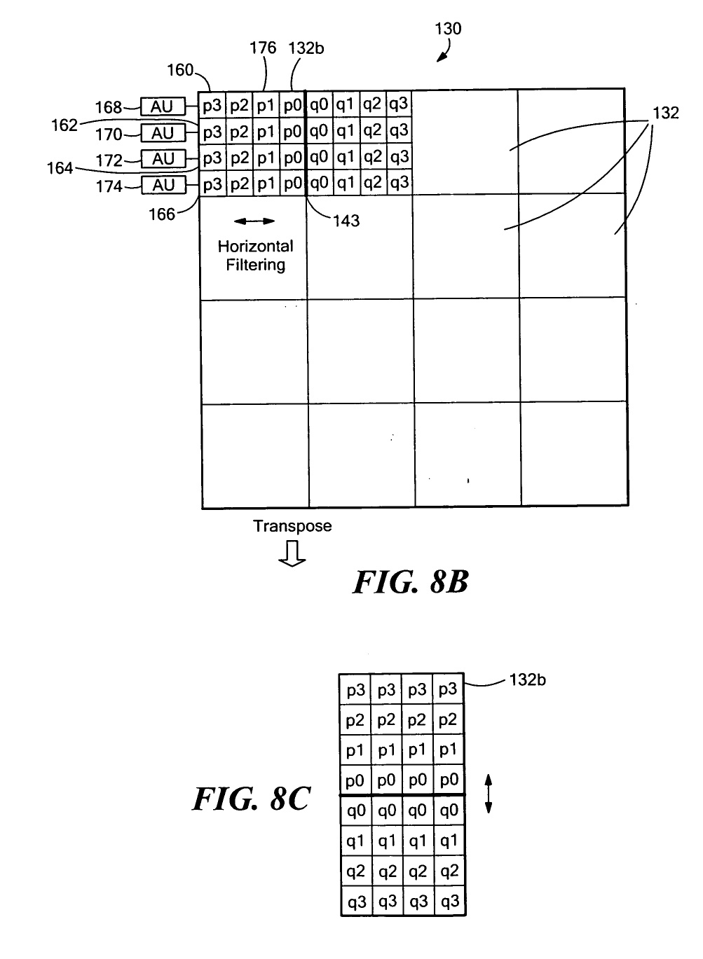

One application of this invention illustrating its great versatility and benefit is described with respect to FIGS. 8A, 8B and 8C. In FIG. 8A there is shown a macro block 130 of an image made up of a sixteen sub blocks 132. Each 4×4 sub block includes sixteen pixels. As an example, sub block 32a, which contains four rows of pixels 134, 136, 138 and 140 containing the pixel values p0 - p3 as shown. In order to remove edge effects at edge 142 vertical and horizontal 143 filtering is done. Vertical filtering is easy enough as each row contains all of the same data, so that a single instruction multiple data operation can be carried out in a vector oriented machine for high speed processing. Thus, the filtering algorithm can be carried out on each column 144, 146, 148, 150, simultaneously, by four different arithmetic units, 152, 154, 156, and 158 respectively. And when the parallel processing is over, the results will all occur, for example, in row 140 and be submittable in one cycle to the next operational register or memory register. Another advantage that occurs in FIG. 8A where the data is arranged in native order for processing by the machine is that as soon as, for example, the two DAG pointer registers 74 and 76 load rows 134 and 136, the arithmetic units 152-158 can begin working.

In contrast, for horizontal filtering, FIG. 8B, all four rows 160, 162, 164, 166 have to be loaded before arithmetic units 168, 170, 172, 174 can begin operations. In addition when the filtering operation is over the outputs p0 in column 176 have to be put out one byte at a time for they are in four different registers in contrast with the ease of read out the pixels p0 in row 140 in FIG. 8A. In order to do this there has to be additional programming to deal with the non-native configuration of the data. By using the permutation circuits, for example, one of the transposed circuits 26a or 26b the pixel data in rows 160, 162, 164, 166 can be transposed on the load into four arithmetic unit data registers R0, R1, R2 and R3 as shown in FIG. 8C so that it now aligns with the native domain of the processing machine as in FIG. 8A. Now the loading proceeds more quickly, the arithmetic unit can begin operating sooner and the results can be output an entire word four bytes at a time.

Although in the example thus far, the invention is explained in terms of the manipulation of bytes, this is not a necessary limitation of the invention. Other data elements larger or smaller could be used and typically multiples of bytes are used. In one application, for example, two bytes or sixteen bits may be the data element. Thus, with the permutable address mode the efficiency of vector oriented processing, such as, SIMD is greatly enhanced. The permutations are particularly effective because they occur in the address mode external to the arithmetic unit. They thereby avoid pipeline stall and do not interfere with the operation of the arithmetic units. The conversion or permutation is done on the fly under the control of the DAG 16 and sequencer 18 during the address mode of operation either loading or storing. The invention allows a unified data presentation which thereby unifies the problem solving. This not only reduces the programming effort but also the time to market for new equipment. This unified data presentation in the native domain of the processor also makes faster use of the arithmetic units and faster storing as just explained. It makes easy accommodation of big endian, little endian or mixed endian operations. It enables data in any form to be reordered to a native domain form of the machine for fast processing and if desired it can then be reordered back to its original form or some other form for use in subsequent arithmetic operations or for permanent or temporary storage in memory.

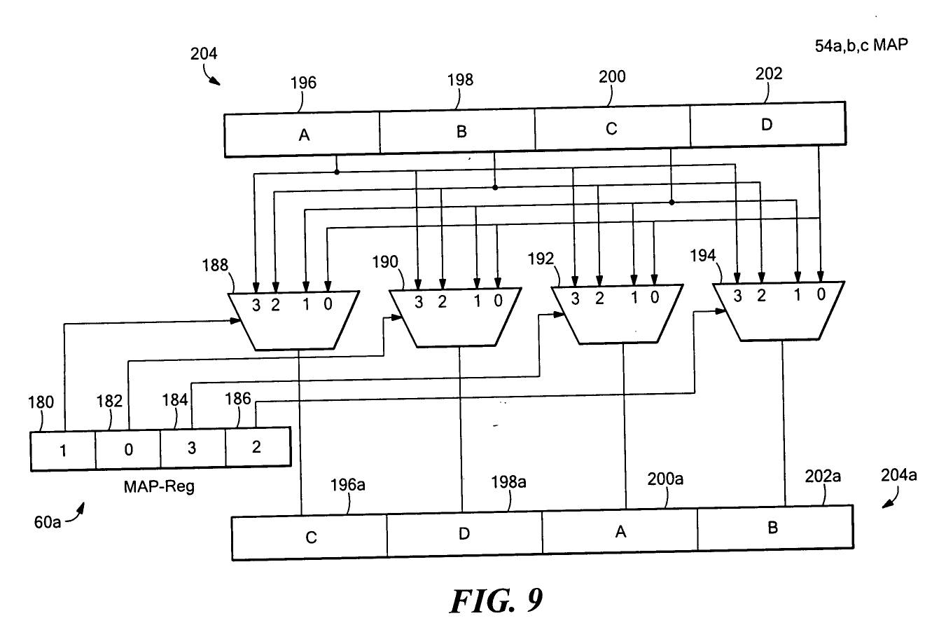

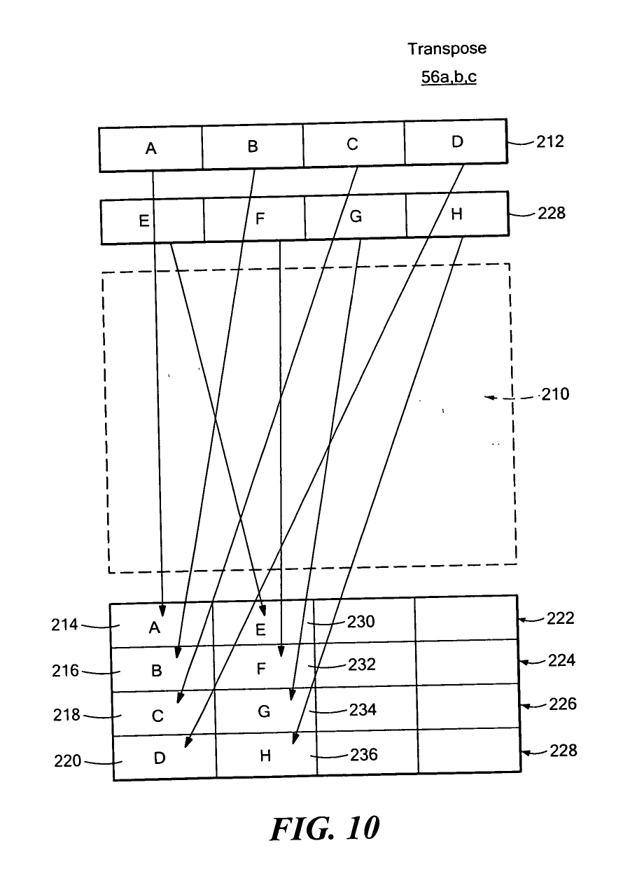

One implementation of a map circuit 54a, b, c is shown in FIG. 9, where one of the MAPA/MAPB registers, for example, 60a is programmed. Here again it includes a field, 180, 182, 184, and 186 for every data element, e.g., byte, which are typically loadable from the arithmetic unit 14. Map register 60a drives switches 188, 190, 192, 194. In operation a thirty-two bit word having four bytes A, B, C, and D in four sections 196, 198, 200, 202 of register 204 are mapped to register 204a so that register sections 196a, 198a, 200a, 202a receive bytes C, D, A, and B respectively. This is done by applying the instructions in each field 180, 182, 184, 186 to switches 188, 190, 192 and 194. For example: the instruction for field 180 is a 1 telling switch 188 to connect C which enables input 1 from byte C in section 200 of register 204; field 182 provides 0 to switch 190 which causes it to deliver byte D from section 202 of register 204 to section 198a of register 204a and so on. One implementation of transpose circuit 56a, b, c, may include a straightforward hardwired network 210, FIG. 10, which connects the row of bytes A, B, C, D in register 212 to the first sections 214, 216, 218 and 220 of registers 222, 224, 226, and 228 respectively. E, F, G, and H from register 228 likewise are hardwired through network 210.

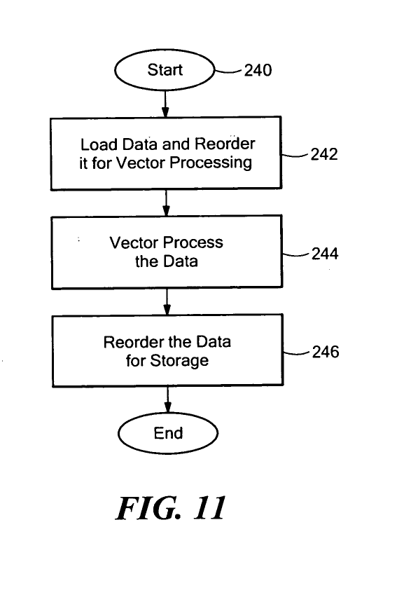

The method according to this invention is shown in FIG. 11. At the start, 240, data is loaded and reordered for vector processing 242, the data is then vector processed 244 and the data is then reordered for storage 246. The data can come in any format and will be reformatted to the native domain of the vector processing machine. After vector processing, for example, SIMD processing, the data can be stored as is, if that is its desired format or it can be reordered again, either to the original format or to some other format. It may be stored in the original storage or in another storage device, such as a register file in the arithmetic unit where it is to be used in the near future for subsequent processing.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A processor with a permutable address mode comprising:
an arithmetic unit including a register file;
at least one load bus and at least one store bus interconnecting said register file with a storage device; and
a permutation circuit in at least one of said buses for reordering the data elements of a word transferred between said register file and storage device.

2. The processor of claim 1 in which each of said load and store buses includes a said permutation circuit.

3. The processor of claim 1 in which there are two load buses and each of them include a permutation circuit.

4. The processor of claim 1 in which said permutation circuit includes a map circuit for reordering the data elements of a word transferred between said register file and storage device.

5. The processor of claim 1 in which said permutation circuit includes a transpose circuit for reordering the data elements of a word transferred between said register file and storage device.

6. The processor of claim 4 in which said register unit includes at least one register.

7. The processor of claim 5 in which said register file includes at least one register.

8. The processor of claim 4 in which said map circuit includes at least one map register.

9. The processor of claim 8 in which said map register includes a field for every data element.

10. The processor of claim 8 in which said map register is loadable from said arithmetic unit.

11. The processor of claim 8 in which at least one of said map registers is default loaded with a big endian little endian map.

12. The processor of claim 1 in which said data elements are bytes.

13. A method of accommodating a processor to process a number of different data formats comprising:
loading a data register with a word from a storage device;
reordering it to a second format compatible with the native order of the vector oriented arithmetic unit before it reaches the arithmetic unit data register file; and
vector processing the data register word in said arithmetic unit.

14. The method of claim 13 storing the result of the vector processing in a second data register device.

15. The method of claim 13 in which the stored result may be reordered to said first format.

16. The method of claim 13 in which said second storage device and said first storage device are included in the same storage.
